(19) United States
(12) Patent Application Publication
(10) Pub. No.: US 2007/0199178 A1
(43) Pub. Date: Aug. 30, 2007

(54) Hinge

(76) Inventor: Tsutomu Katsumata, Higashiosaka-shi (JP)

Correspondence Address: JORDAN AND HAMBURG LLP, 122 EAST 42ND STREET, SUITE 4000, NEW YORK, NY, 10168, US

(21) Appl. No.: 11/652,878

(22) Filed: Jan. 11, 2007

(30) Foreign Application Priority Data
Jan. 12, 2006 (JP) 2006-005112

(51) Int. Cl. E05F 1/08

(52) U.S. Cl. 16/286

(57) ABSTRACT

A hinge in which an opening/closing side member such as a cover is attached to a rotation arm rotatably pivot-mounted via a spindle to a hinge case attached to a stationary side member of a device body of a copier or the like, and opening-direction torque is applied to the opening/closing side member, comprising a cam integrally provided at the bottom of the rotation arm base, a slider accommodated in the hinge case so as to vertically slide therein, and a spring accommodated in the slider and causing the slider to elastically abut the cam, wherein in the range from the rotation arm being in a closed state to a state of its being opened to a prescribed angle, opening-direction torque is applied to the rotation arm.

A substitute specification and abstract is provided herewith to facilitate prosecution of the application. Additionally, a marked reproduction of the original specification and abstract, showing changes effected in the substitute specification and abstract, is submitted herewith.

### BACKGROUND OF THE INVENTION

The present invention relates to a hinge wherein an opening/closing side member is attached to a rotation arm rotatably pivot-mounted to a hinge case attached to a stationary side member, and opening-direction torque is applied to the opening/closing side member.

One conventional hinge of this type is a hinge in which a movable part is swingably connected to a base, and opening-direction torque is applied to the movable part, comprising a housing (hinge case) locked with one of the movable part or the base, a cam base (rotation arm) locked with the other one of the movable part or the base and swingably connected to the housing, a plunger (slider) accommodated in the housing so as to freely move back and forth, and having an inclined surface that approaches the cam base swinging shaft between the opening direction forward side and the opening direction rear side, an elastic body (spring) accommodated in the housing and pushing the plunger in the direction approaching the swinging shaft, a first cam that swings with the cam base, slides on the inclined surface when the amount of compression of the elastic body is within a prescribed amount of the maximum level, and rotates in the opening direction when the plunger approaches the swinging shaft, and a second cam provided more to the opening direction rear side than the first cam, that swings with the cam base, slides on the inclined surface when the amount of compression of the elastic body is within a prescribed amount of the minimum level, and rotates when the plunger approaches the swinging shaft. (see, for example, Patent Document 1)

However, the conventional hinge has a structure such that torque is applied to an unnecessary range as well, entailing the problems of not only severe wear of a cam, slider and the like, but also large operating noise. Further, in a case where the end of a metal spindle pivot-mounting a rotation arm to a hinge case is crimped to prevent sliding out, the crimped section protrudes therefrom, posing the risk of injury. Also, particularly in a case where a thick manuscript is being pressed down upon, the hinge case may be pulled out from the base. Further, there are such problems that a slider does not smoothly slide, easily wears, and causes abnormal noise due to interference with a spring.

Patent document 1: Laid-open Japanese Patent Application No. 2003-129739

The object of the present invention is to solve the above problems of the conventional technology.

### SUMMARY OF THE INVENTION

A hinge according to the present invention is a hinge in which an opening/closing side member such as a cover is attached to a rotation arm rotatably pivot-mounted via a spindle to a hinge case attached to a stationary side member of a device body of a copier or the like, and opening-direction torque is applied to the opening/closing side member, comprising a cam integrally provided at the bottom of the rotation arm base, a slider accommodated in the hinge case so as to vertically slide therein, and a spring accommodated in the slider and causing the slider to elastically abut the cam, wherein in the range from the rotation arm being in a closed state to a state of its being opened to a prescribed angle, for example, roughly 301, opening-direction torque is applied to the rotation arm. Further, the spindle is made of metal, at least one end thereof is crimped to prevent sliding out, and a recess is formed in the hinge case at the area surrounding the crimping so as to prevent the crimping from protruding therefrom. Further, the hinge case is fixed by attaching a retaining pin at the lower end thereof, and the retaining pin is inserted into a long hole provided in the stationary side member so that the hinge case can vertically move only a prescribed stroke amount. Further, on a slider lateral surface that intersects orthogonally with the axial direction of the spindle, ribs are formed in the sliding direction. Further, at least on the manuscript side lateral surface of the slider, grease puddles are formed. Further, the slider has tapered surfaces formed at the internal corners of the bottom open end.

The hinge according to the present invention demonstrates the following effects.

1) Torque is applied only within the range in which an opening/closing side member is used, thereby, in particular, reducing friction caused by elastic contact between a slider and a cam, and reducing operating noise.

2) The crimped section is beyond a user=s reach, preventing the risk of injury. Further, there is no restriction in terms of the dimension of a hinge set into a rectangular hole of a device body, allowing smaller reduction.

3) Even when a dictionary or other thick manuscript is photocopied, there is no danger of the hinge case being pulled out.

4) Because ribs constitute the sliding surface in friction with the hinge case, with press insertion tolerance, parts can be secured and maintained with high precision, and the noise from collision between slider and rotation arm caused by the restoring force of a spring is reduced. Further, a groove between ribs may be made to serve as a grease puddle, or grease puddles may be provided at least on a manuscript side lateral surface of the slider.

5) There is no possibility of interference noise caused by interference between a spring that repeatedly is compressed and restored, and opening end internal corners at the bottom of the slider.

### BRIEF DESCRIPTION OF THE DRAWINGS

FIG. 1 is a cross-sectional view showing one embodiment of a hinge according to the present invention;

FIG. 2 is a diagram for explaining a crimped section of a spindle;

FIG. 3(A) through (C) are diagrams for explaining the relationship between a rotation arm and a cam;

FIG. 4 is a diagram for explaining the structure of a slider; and

FIG. 5 is a diagram for explaining another embodiment in which grease puddles are formed at least on a manuscript side lateral surface of the slider.

### DETAILED DESCRIPTION OF THE INVENTION

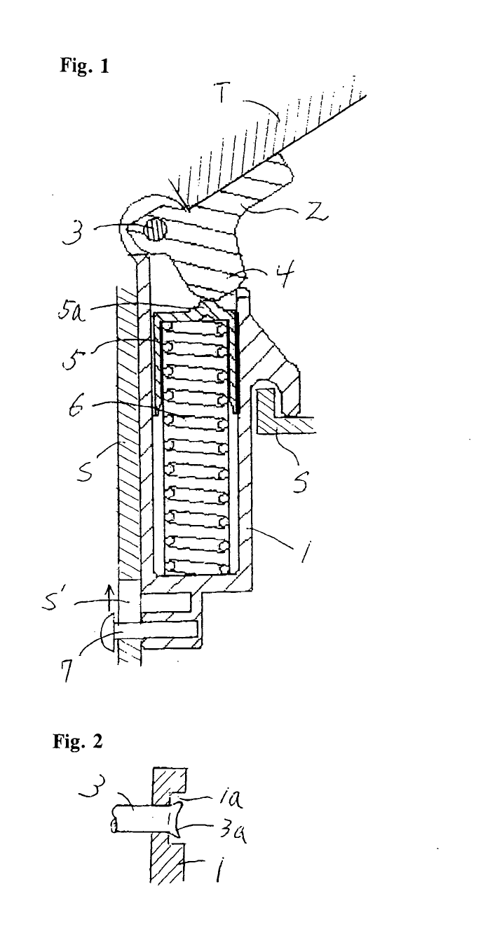

FIG. 1 shows one embodiment of a hinge according to the present invention; I is a hinge case, 2 is a rotation arm, 3 is a spindle, 4 is a cam, 5 is a slider, and 6 is a spring.

The hinge case 1 is provided on a stationary side member S of a device body of a copier or the like so as to vertically slide thereupon. The hinge case 1 is fixed by attaching a retaining pin 7 at the lower end thereof by screwing, pressing or the like. The retaining pin 7 is inserted into a long hole S= provided in the stationary side member S. Therefore, the hinge case 1 can vertically move only a prescribed stroke amount.

The rotation arm 2 is rotatably pivot-mounted at the upper end of the hinge case 1 via the spindle 3. As can be seen in FIG. 2, in a case where the spindle 3 is made of metal, at least one end thereof has been subject to crimping 3a to prevent sliding out. A recess 1a is formed in the hinge case 1 at the area surrounding the crimping 3 by so-called zaguri processing (machining for forming a hole) so as to prevent the crimping 3a from protruding therefrom.

The rotation arm 2 has fixed thereto an opening/closing side member T such as an opening/closing lid, image input part (see above Patent Document 1) or the like. In FIG. 1, the rotation arm 2 clockwise rotation direction is the closing direction for the opening/closing side member T, and its counterclockwise turning direction is the opening direction of the opening/closing side member T.

The rotation arm 2 has a cam 4 integrally provided at the bottom of the base thereof. The cam 4 is configured so as to elastically abut the slider 5. More specifically, the slider 5 is accommodated in the hinge case 1 so as to vertically slide therein, and is made to elastically abut the cam 4 by a spring 6 (compression spring).

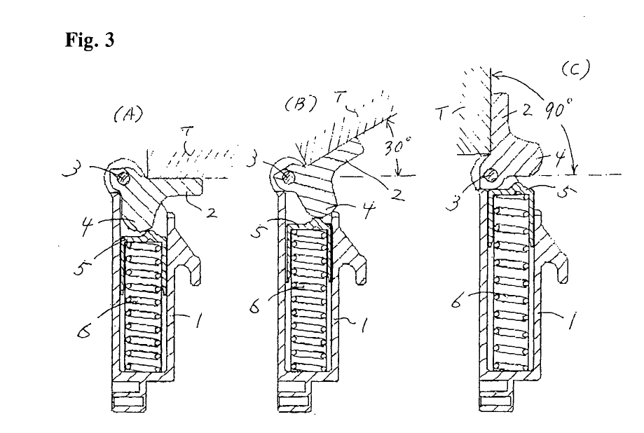

The slider 5 is constituted such that, as shown in FIGS. 3(A) (B), when the rotation arm 2 is positioned at an angle between 01 (closed state) and 301 (half-open state), torque is applied so that a protrusion 5a opens the rotation arm 2 via the cam 4. When the rotation arm 2 is positioned at angle between 301 and 901 (fully opened state), as shown in FIGS. (B) and (C), no such torque operates, and the arm is in a free state.

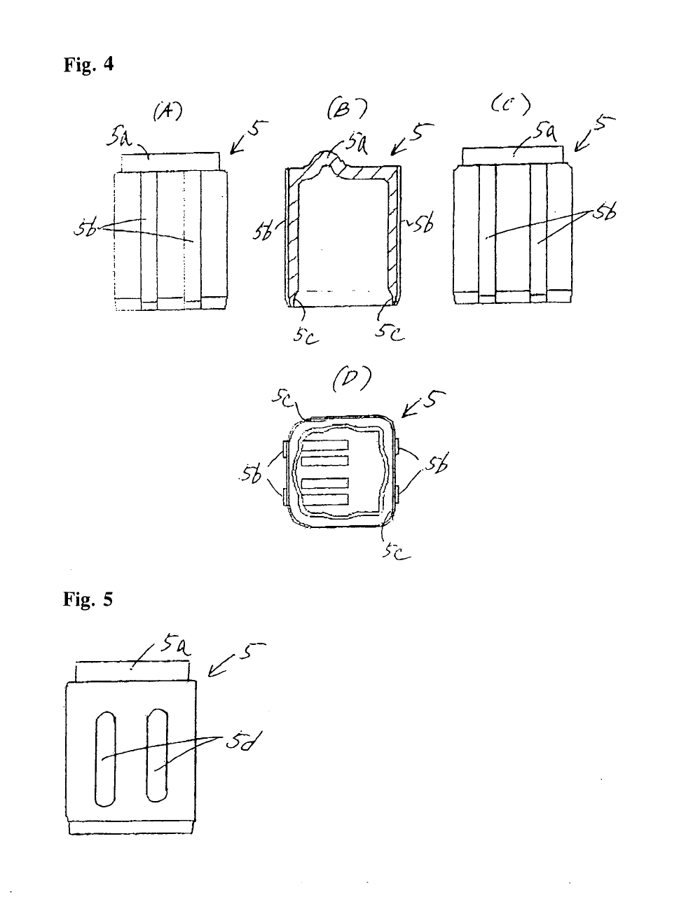

As can be seen in FIG. 4, the slide 5 has a box shape with an open bottom, and the upper surface thereof is provided with a protrusion 5a that abuts the cam 4. Further, on lateral surfaces of the slider 5, more specifically, lateral surfaces that intersect orthogonally with the axial direction of the spindle 3, ribs 5b (two ribs in this embodiment) are formed in the sliding direction. Further, the slider 5 has tapered surfaces 5c formed at the internal corners of the bottom open end.

Next, operations of the hinge and the effects thereof will be explained.

As shown in FIG. 1, the hinge according to the present embodiment is provided with a cam 3 integrally provided at the bottom of the base of the rotation arm 2, a slider 5 accommodated in the hinge case 1 so as to vertically slide therein, and a spring 6 accommodated in the slider 5 so as to cause the slider to abut the cam 3, wherein in the range from the rotation arm 2 being in a closed state to a state of being opened to a prescribed angle, for example, 301, opening-direction torque is applied to the rotation arm. Therefore, torque is applied only in the range where the opening/closing side member is used, reducing in particular friction caused by elastic contact of the slider 5 and the cam 3, and reducing operating noise.

In a case where the spindle 3 is made of metal, and at least one end thereof is treated by crimping 3a so as to prevent its sliding out, a user may suffer a hand injury by accidentally touching the edge of the crimping 3a. With a recess 1a formed in the hinge case 1 at the area surrounding the crimping 3a so as to prevent the crimping 3a from protruding therefrom, the crimping 3a is beyond the user=s reach, eliminating the risk of injury. Further, when the hinge is to be set in a rectangular hole of a device body, there are no dimensional restrictions, and less space is used.

A retaining pin 7 is attached to the lower end of the hinge case 1, the retaining pin 7 is inserted into a long hole S= provided on the stationary side member S, and the hinge case can vertically move for just a prescribed stroke amount; therefore, when a dictionary or other thick manuscript is photocopied, there is no danger of the hinge case 1 being pulled out.

On lateral surfaces of the slider 5 that intersect orthogonally with the axial direction of the spindle 3, ribs 5b are formed in the sliding direction, and the ribs 5b constitute sliding surfaces in friction with the hinge case 1. Thus not only can parts be secured and maintained with high precision with the press insertion tolerance, but noise from collision of the slider 5 and the rotation arm 2 caused by a restoring force of the spring 6 is reduced. Further, the groove between the ribs 5b can be made to serve as a grease puddle. As an alternative to the grease puddle or the groove between the ribs 5b, as shown in FIG. 5, grease puddles 5d may be formed at least on the manuscript side lateral surfaces of the slider 5, so that grease does not flow out from the top of the slider 5 at time of opening.

The slider 5 has tapered surfaces 5c formed at the internal corners of the bottom open end, preventing interference noise caused by interference between the spring 6 that is repeatedly compressed and restored, and the internal corners at the bottom open end of the slider 5.

1-25. (canceled)

26. A hinge comprising:
a hinge case;
a rotation arm rotatably pivot-mounted to the hinge case;
a cam integrally provided at a bottom of a base of the rotation arm;
a slider accommodated in the hinge case so as to vertically slide therein; and
a spring accommodated in the slider so as to cause the slider to elastically abut the cam and thereby apply an opening-direction torque to the rotation arm in a range from the rotation arm being in a closed state to the rotation arm being at a predetermined angle.

27. A hinge according to claim 26, wherein the predetermined angle is approximately 30°.

28. A hinge according to either claims 26 or 27, further comprising a spindle made of metal wherein the rotation arm is rotatably pivot-mounted via the spindle to the hinge case, at least one end of the spindle is crimped to prevent sliding out, and a recess is formed in the hinge case at the area surrounding the crimped end of the spindle so as to prevent the crimping from protruding therefrom.

29. A hinge according to claims 26 or 27, further comprising:
a retaining pin affixed to a lower end of the hinge case; and
a stationary side member wherein the retaining pin is inserted into a hole in the stationary side member, the hole being sized such that the hinge case can vertically move a predetermined amount.

30. A hinge according to claims 26 or 27, wherein the slider has one or more lateral surfaces that intersect orthogonally with the axial direction of the spindle and ribs are formed upon said lateral surfaces in the vertical direction.

31. A hinge according to claims 26 or 27, wherein the slider has one or more lateral surfaces, and at least on the lateral surface that both intersects orthogonally with the axial direction of the spindle and is within an angle formed in a closing-direction between the spring and the rotation arm, one or more grease reservoirs are formed.

32. A hinge according to claims 26 or 27, wherein the slider has a bottom open end having internal comers, said internal corners having tapered surfaces.

33. A hinge according to claim 28, further comprising:
a retaining pin affixed to a lower end of the hinge case; and
a stationary side member wherein the retaining pin is inserted into a hole in the stationary side member the hole being sized such that the hinge case can vertically move a predetermined amount.

34. A hinge according to claim 28, wherein the slider has one or more lateral surfaces that intersect orthogonally with the axial direction of the spindle and ribs are formed upon said lateral surfaces in the vertical direction.

35. A hinge according to claim 29, wherein the slider has one or more lateral surfaces that intersect orthogonally with the axial direction of the spindle and ribs are formed upon said lateral surfaces in the vertical direction.

36. A hinge according to claim 33, wherein the slider has one or more lateral surfaces that intersect orthogonally with the axial direction of the spindle and ribs are formed upon said lateral surfaces in the vertical direction.

37. A hinge according to claim 28, wherein the slider has one or more lateral surfaces, and at least on the lateral surface that both intersects orthogonally with the axial direction of the spindle and is within an angle formed in a closing-direction between the spring and the rotation arm, one or more grease reservoirs are formed.

38. A hinge according to claim 29, wherein the slider has one or more lateral surfaces, and at least on the lateral surface that both intersects orthogonally with the axial direction of the spindle and is within an angle formed in a closing-direction between the spring and the rotation arm, one or more grease reservoirs are formed.

39. A hinge according to claim 33, wherein the slider has one or more lateral surfaces, and at least on the lateral surface that both intersects orthogonally with the axial direction of the spindle and is within an angle formed in a closing-direction between the spring and the rotation arm, one or more grease reservoirs are formed.

40. A hinge according to claim 28, wherein the slider has a bottom open end having internal comers, said internal corners having tapered surfaces.

41. A hinge according to claim 29, wherein the slider has a bottom open end having internal corners, said internal corners having tapered surfaces.

42. A hinge according to claim 30, wherein the slider has a bottom open end having internal comers, said internal corners having tapered surfaces.

43. A hinge according to claim 31, wherein the slider has a bottom open end having internal corners, said internal comers having tapered surfaces.

44. A hinge according to claim 33, wherein the slider has a bottom open end having internal comers, said internal corners having tapered surfaces.

45. A hinge according to claim 34, wherein the slider has a bottom open end having internal corners, said internal corners having tapered surfaces.

46. A hinge according to claim 35, wherein the slider has a bottom open end having internal corners, said internal corners having tapered surfaces.

47. A hinge according to claim 36, wherein the slider has a bottom open end having internal corners, said internal corners having tapered surfaces.

48. A hinge according to claim 37, wherein the slider has a bottom open end having internal corners, said internal corners having tapered surfaces.

49. A hinge according to claim 38, wherein the slider has a bottom open end having internal corners, said internal corners having tapered surfaces.

50. A hinge according to claim 39, wherein the slider has a bottom open end having internal corners, said internal corners having tapered surfaces.
